(19) United States
(12) Patent Application Publication
(10) Pub. No.: US 2002/0153850 A1
(43) Pub. Date: Oct. 24, 2002

(54) Automated ceremonial lighting

(76) Inventor: Gabor Lederer, Paterson, NY (US)

Correspondence Address: ISRAEL NISSENBAUM, 1038-56TH ST, BROOKLYN, NY, 11219, US

(21) Appl. No.: 09/840,282

(22) Filed: Apr. 23, 2001

(51) Int. Cl. H05B 37/02

(52) U.S. Cl. 315/291

(57) ABSTRACT

An electronic timer and sequence circuitry for lighting of ceremonial lights (e.g., Hanukah, Kwaanza, Christmas) in sequence. The device contains clock generator, memory circuitry and a sequence of events generator and a flickering light to simulate candle appearance.

### FIELD OF THE INVENTION

This invention relates to the automatic lighting of ceremonial lights and specifically ceremonial lights being lit with variations in time and number.

### BACKGROUND OF THE INVENTION

Often religious holidays entail the lighting of candles or lights in specific sequence and number. For example the Jewish holiday of Hanukah, also known as the Festival of Lights, requires the sequential lighting of candles or lights over a period of eight days with the number of lights corresponding to the day of the holiday, i.e., one on the first day, two on the second, three on the third, etc.

The celebration of Kwaanza entails a similar requirement over a period of seven days. Christmas, while not having specified lighting requirements, is often visually celebrated with the lighting of strings of lights and candles in various numbers.

The lighting of candles and lights, with varying sequence and number, generally requires some effort. This effort includes numerical calculation, and the actual presence of the celebrant at the appropriate times and site for the lighting or setting and activating of the requisite number of lights at the specific times and in requisite configurations. This is particularly problematic in office buildings and other work sites wherein displays including such lights are made in deference of the various beliefs of the employees but wherein failure to correctly light the lights in sequence at the proper times may be insulting in actual practice.

### SUMMARY OF THE INVENTION

It is accordingly an object of the present invention to provide an automatic means for the lighting of ceremonial lights for occasions calling for such lighting in predetermined number and at pre-determined times for pre-set or pre-determined dates of holidays or events.

It is a further object of the present invention to provide such lighting as an automatic function without the necessity for setting or lighting intervention or specific knowledge of holiday or event lighting requirements.

Generally the present invention comprises a device for electrically lighting lights, such as holiday ceremonial lights, in a specifically required or desired sequence and number, at specified times and days. The device comprises an electronic timer coupled with pre-assigned sequence circuitry means adapted to remember and effect the lighting, as required or desired, in a proper form and sequence for a holiday, event or occasion for which sequential timed lighting is desired. In addition, the device comprises means for remembering and effecting continual lighting of the correct number of lights at the desired time every day without personal intervention. The device is operably powered by an AC outlet or by internally contained rechargeable or disposable batteries.

In a preferred embodiment, the lights are in the form of electrically simulated candles having a realistic flicker element such as disclosed in U.S. Pat. No. 6,066,924, issued May 23, 2000, by the inventor herein, and the light source may be any of a number of light bulbs or light emitting diodes (LEDs). The electrically simulated candles have the additional benefit, for non-traditionalists who do not insist on lighting candles, of reducing the risk of fire.

The above and further objects, features and advantages of the present invention will become more evident from the following discussion and drawings in which:

### SHORT DESCRIPTION OF THE DRAWINGS

FIG. 1 is a typical electrically powered Hanukah menorah showing the sequence of daily lighting; and

FIG. 2 is a block diagram outlining the operation of the device of the present invention as used with the menorah of FIG. 1 and similar ceremonial lights.

### DETAILED DESCRIPTION OF THE INVENTION

The device of the present invention includes a sequence of event generator as an overall controller of the timing function. The device further comprises a clock generator as the timer, memory and optionally power management means (of particular use with battery powered devices with limited available battery power.

Though different versions of the device may be utilized and adapted specifically for the occasion it is preferred that a single device contain the instructions and controls for the controlled operation and lighting of lights for various recognized occasions.

### DETAILED DESCRIPTION OF THE DRAWINGS AND THE PREFERRED EMBODIMENTS

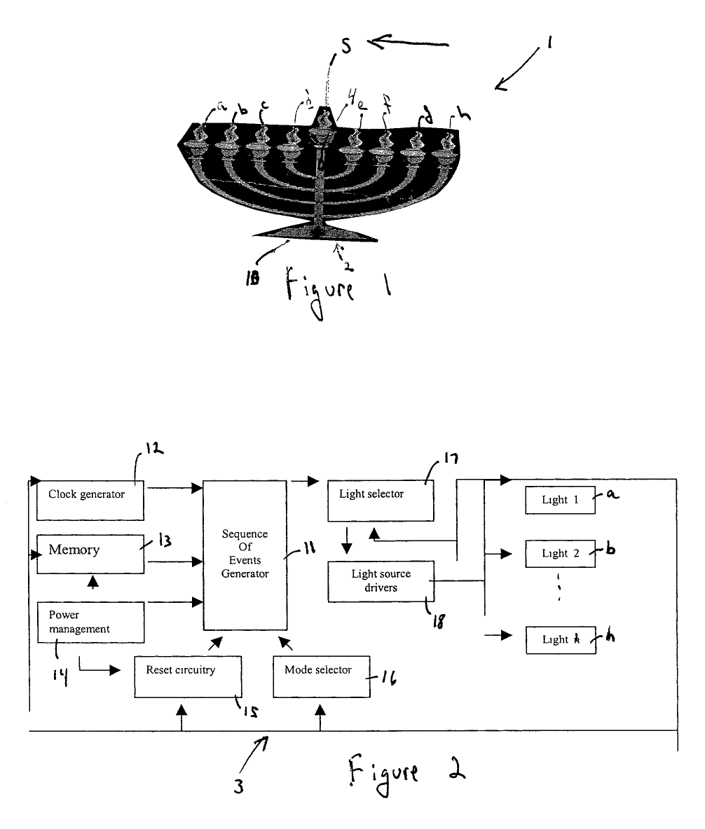

With respect to the drawings, in FIG. 1, fully lit menorah 1 has eight candles or lights a-h as it appears on the eighth day of the holiday (elevated server light S is lit on every night). From the beginning of Hanukah, a first light is lit and an additional light or candle is lit for each succeeding day of the holiday at nightfall and in the direction as indicated by the arrow. In order to effect the sequential lighting at nightfall and with the proper lights, the device 10 of the present invention is contained within the base 2 of menorah 1, with the operational functional elements shown in FIG. 2.

The device 10 is electrically connected to the lights a-h of menorah 1 in the interior thereof (not shown) and is activated, with the appropriate lighting sequence and timing, by activation of switch 4.

The device 10 comprises sequence of events generator 11 which includes controller and driver circuitry. Clock generator 12, memory 13 and power management circuitry 14 are linked to the sequence of events generator 11 to provide a timing function, to contain lighting and sequence requirements and to manage battery power respectively. Battery power is conserved by shutting down the unused sections of the controller and driver circuitries to reduce power consumption when power is not needed.

The reset circuitry 15, linked to the sequence of events generator, serves two functions. If a first time event (e.g., the lighting of the first “candle”) is missed, the reset circuitry 15 serves to restore the device to the correct sequence and at the end of an event it serves to reset the circuitry to an initial ready state.

The mode selector switch 16 provides a choice between a specific celebration mode and a random mode. This enables the device to be used in a random lighting sequence and for variable lengths of time whereby the light, normally dedicated for single holiday usage, may be used as a decorative item during the remainder of the year.

The time or light selector switch 17 enables the lights a, b . . . h to be lit for different lengths of time (e.g., for 8 hours or 24 hours, etc.). The light source drivers 18 are connected to the lights to power the selected lights at the predetermined times.

It is understood that the above example and drawings are merely exemplary of the present invention and that changes in number and sequence of lights as well as lighting configuration, type of lighting and particular purpose, event or holiday and the like may differ without departing from the scope fo the present invention as defined in the following claims.

What is claimed is:

1. A device for electrically lighting lights in a specifically desired sequence and number at specified times, said device comprising an electronic timer coupled with pre-assigned sequence circuitry means adapted to remember and effect the lighting, as desired, in a proper form and sequence for a holiday, event or occasion for which sequential timed lighting is desired.

2. The device of claim 1 for use in conjunction with an electric light having at least two light sources, wherein said device is programmed to effect lighting of said lights in a predetermined sequence and number over a period of a pre-selected number of days.

3. The device of claim 2 wherein said pre-determined sequence and number correlates lighting requirements of a holiday or a celebration.

4. The device of claim 1, wherein the device comprises means for remembering and effecting continual lighting of the correct number of lights at the desired time every day without personal intervention.

5. The device of claim 1, wherein said device is operably powered by one of an AC outlet, internally contained disposable batteries, and internally contained rechargeable batteries.

6. The device of claim 4, wherein the device further includes a sequence of events generator, as an overall controller of the timing function, and a clock generator as the electronic timer.

7. The device of claim 6, wherein the device further comprises power management means to control and extend available limited available battery power, when the device is battery powered.

8. The device of claim 1, wherein said device comprises a sequence of events generator which includes controller and driver circuitry; a clock generator; memory means and power management circuitry 14; wherein the clock generator is linked to the sequence of events generator to provide a timing function and to contain lighting and sequence requirements and said power management circuitry is adapted to manage battery power by shutting down the unused sections of the controller and driver circuitries to save power consumptions when not needed.

9. The device of claim 8, wherein the device further comprises reset circuitry 15, linked to the sequence of events generator, wherein if a first time event is missed, the reset circuitry 15 is adapted to restore the device to a correct desired sequence and wherein at the end of an event the reset circuitry serves to reset the circuitry.

10. The device of claim 9 wherein the device further comprises a mode selector switch adapted to provide a choice between a specific celebration mode and a random time and sequence lighting mode.
